(19) United States
(12) Patent Application Publication
(10) Pub. No.: US 2024/0303649 A1
(43) Pub. Date: Sep. 12, 2024

(54) SYSTEMS AND METHODS FOR SECURE AUTHENTICATION THROUGH NEAR FIELD COMMUNICATION

(71) Applicant: Capital One Services, LLC, McLean, VA (US)

(72) Inventors: Kevin OSBORN, Newton Highlands, MA (US); Jeffrey RULE, Chevy Chase, MD (US)

(21) Appl. No.: 18/119,594

(22) Filed: Mar. 9, 2023

(51) Int. Cl. G06Q 20/40; G06Q 20/10; G06Q 20/32; H04L 9/32; H04L 9/40; H04W 12/06

(52) U.S. Cl. CPC G06Q 20/40; G06Q 20/1085; G06Q 20/322; G06Q 20/3278; H04L 9/3228; H04L 63/0853; H04W 12/06

(57) ABSTRACT

Systems and method for verifying a user's identity through SMS and NFC are provided. The system includes a card, a user device, and a sever. The method comprises requesting an authentication credential, opening a communication field, sharing information sufficient to create an authentication credential, sending the credential to a server, validating the user's identity, and performing a transaction. This method improves security and decreases the time needed to verify a user's identity.

### FIELD OF THE DISCLOSURE

The present disclosure relates to systems and methods for secure authentication through messaging and near field communication.

### BACKGROUND

Mobile or web applications are often used to confirm a mobile user's identity. For example: A user wants to buy something from a website. To confirm the user's identity, the website sends the user a uniform resource locator (URL) link. The user clicks the link and is directed to a separate website or mobile application where the user is prompted with a one-time-password. This two-factor authentication adds an extra layer of security and helps prevent fraudulent parties from buying products using the user's stolen information.

However, this method is vulnerable in several ways. For example, a fraudulent party can steal a user's mobile device, receive the one-time-password, and buy something in the user's name. As another example, a fraudulent party can intercept a one-time password when it is sent over a network. Indeed, any short message service (SMS) or a multimedia message service (MMS) can be intercepted while it is being sent to the user, thus putting the user at risk of sharing sensitive information. As another example, if a user's phone is stolen, then SMS or MMS messages received on the stolen phone can be used by a fraudulent party to gain access to a user's account.

These and other deficiencies exist. Therefore, there is a need to provide systems and methods that overcome these deficiencies and provide for secure authentication.

### SUMMARY OF THE DISCLOSURE

Aspects of the disclosed embodiments include systems and method for employing short message service (SMS) messaging and near field communication (NFC) for validating a user's identity.

Embodiments of the present disclosure provide a system for validating a user's identity, the system comprising: a card, a user device, and a server. The server further comprises a memory, and a processor. The processor is configured to transmit an authentication request to the user device, the authentication request further comprising a uniform resource locator (URL). Then, the processor opens, in response to the authentication request, a communication field between the user device and the card. Then the processor receives an authentication credential from the card, validate the authentication request, and perform a transaction.

Embodiments of the present disclosure provide a method for validating a user's identity, the method comprising the steps of: transmitting, by a processor, an authentication request to a user device, the authentication request further comprising a uniform resource locator (URL). Next, directing, by a processor, the user device to an application, then opening a communication field between a user device and a card. Next, receiving, by a processor, an authentication credential from the card, validating the authentication request, and performing a transaction.

Embodiments of the present disclosure provide A computer readable non-transitory medium comprising computer executable instructions that, when executed on a processor, perform procedures comprising the steps of: transmitting, by a processor, an authentication request to a user device, the authentication request further comprising a uniform resource locator (URL); directing, by a processor, the user device to an application; opening a communication field between a user device and a card; receiving, by a processor, an authentication credential from the card; validating the user device; and performing a transaction.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a diagram illustrating a contactless card according to an exemplary embodiment.

FIG. 3 is a diagram illustrating a contact pad of a contactless card according to an exemplary embodiment.

FIG. 4 is a method flowchart illustrating a method of cryptography according to an exemplary embodiment.

FIG. 5 is a diagram illustrating a near field communication (NFC) field according to an exemplary embodiment.

FIG. 6 is a flowchart illustrating a process according to an exemplary embodiment.

FIG. 7 is a diagram illustrating a process of user verification according to an exemplary embodiment.

FIG. 8 is a sequence diagram illustrating a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner and the features, advantages, and characteristics of any embodiment can be interchangeably combined with the features, advantages, and characteristics of any other embodiment. One skilled in the relevant art will recognize that the embodiments may be practiced without one or more of the specific features or advantages of an embodiment. In other instances, additional features and advantages may be recognized in certain embodiments that may not be present in all embodiments.

The diagrams and flowcharts in the figures illustrate the architecture, functionality, and operation of possible implementations of systems, methods, and computer program products according to various embodiments of the present invention. In this regard, each block in the flowcharts or diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments described herein relate to systems and methods for verifying a user's identity using SMS and NFC technology. In an exemplary embodiment, the user wants to perform a transaction through a website or application. Before the website approves the transaction, the website needs to confirm the user's identity. To do so, the website sends a URL to the user's device. Through the user device, the user accesses the URL and is directed either to a website or a mobile application. In either scenario, the user is prompted to tap their contactless card to their mobile device through NFC. Through diversified key exchange, the card and the mobile device share secret information that is sufficient to confirm the user's identity. The authentication credential is sent back to the website or server which validates the user's identity. Once validated, the user can proceed with the transaction.

These systems and methods cure deficiencies in the present one-time password usage in modern transactions. A one-time-password can be intercepted over a network, or a fraudulent party may steal the user's mobile device. In contrast, an NFC verification requires both a mobile device and a contactless card. The combination of these two things heightens the level of security needed to perform a transaction. Because NFC requires a very close range of communication, it is infeasible for a fraudulent party to intercept the identity information being shared between the contactless card and the mobile device. Additionally, NFC communication is quicker than typing and sending a one-time password. In combination with a URL linked to a website or mobile application, this exemplary process allows the user to verify their identity wherever they take their user device and card. This provides more opportunities for users to verify their identity from any location.

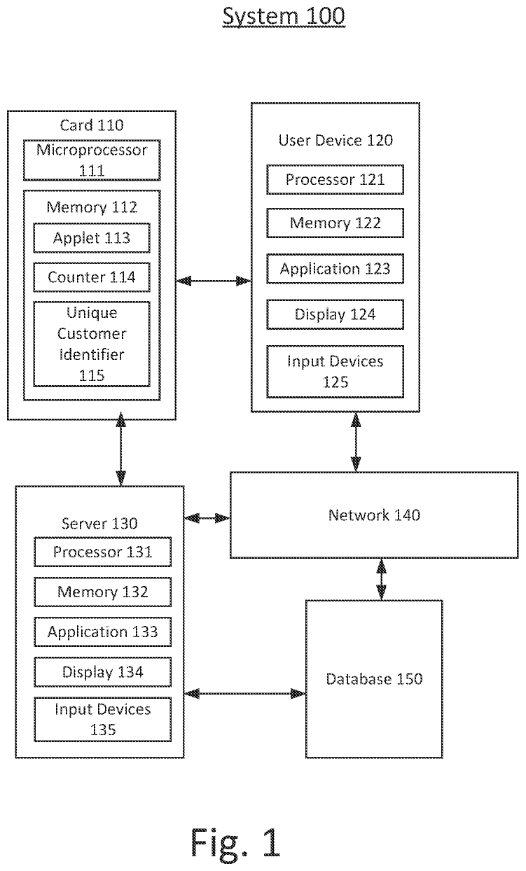

FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

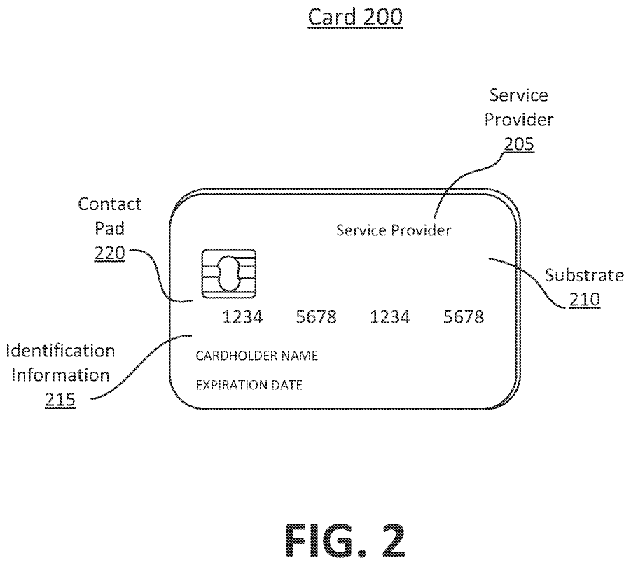

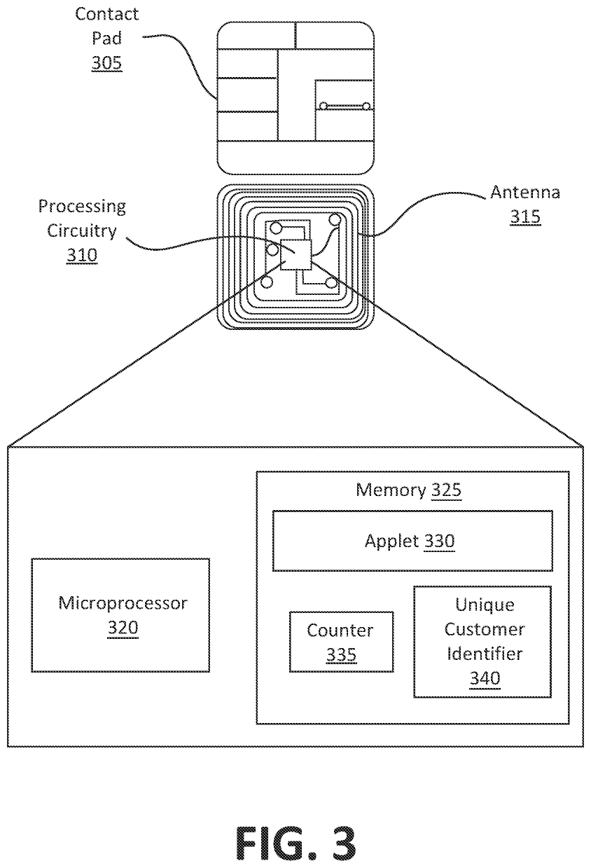

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the card 110, retaining a web session between the user device 120 and the card 110, and masking private data received from the user device 120 and the card 110. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the card 110. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 is a diagram of a card according to an exemplary embodiment.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2 and FIG. 3. These components may be located behind the contact pad 220 or elsewhere on the substrate 210. The contactless card 200 may also include a magnetic strip or tape, which may be located on the back of the card (not shown in FIG. 2).

FIG. 3 illustrates a contact pad 305 of a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet, and perform the functions described herein. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NFC Data Exchange Format (NDEF) message that comprises a cryptographically secure OTP encoded as an NDEF text tag.

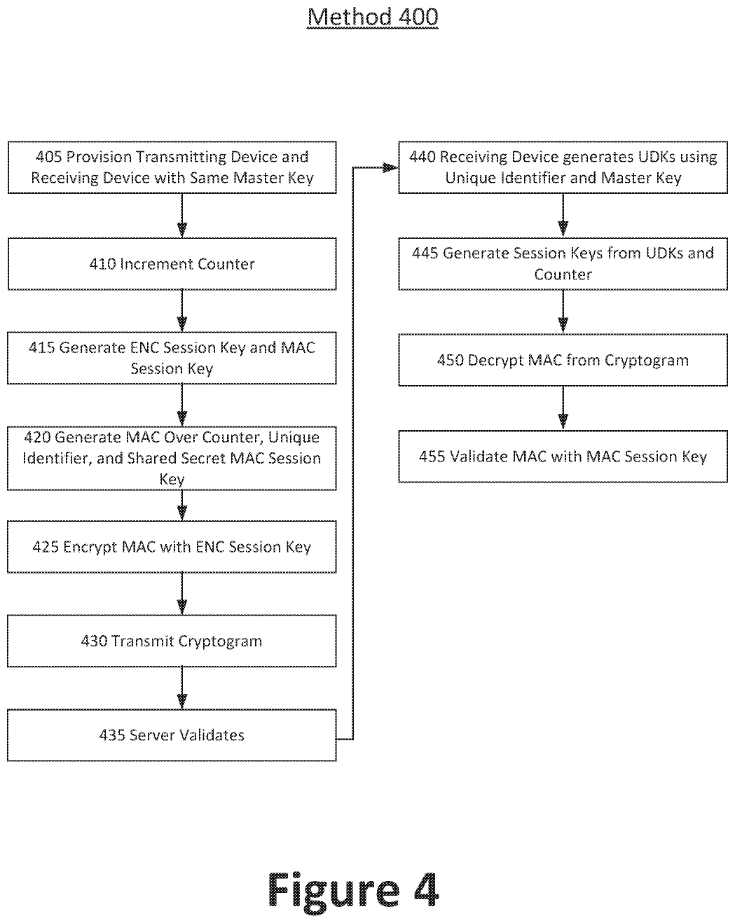

FIG. 4 is a flow chart of method 400 of key diversification according to an example of the present disclosure.

In some examples, a sender and recipient may desire to exchange data via a transmitting device and a receiving device. It is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like.

The method 400 can begin with Step 405. In step 405, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the sender may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 410, the transmitting device may take the selected cryptographic algorithm, and using the master symmetric key, process the counter value. For example, the sender may select a symmetric encryption algorithm, and use a counter which updates with every conversation between the transmitting device and the receiving device. The one or more counters may comprise a numeric counter sufficient to store an integer. The processor may increment the counter one or more times.

In step 415, the transmitting device generates two session keys: one ENC (encryption) session key and one MAC (message authentication code) session key. The transmitting device may encrypt the counter value with the selected symmetric encryption algorithm using the master symmetric key to create a session key.

In step 420, the processor generates the MAC over the counter, the unique customer identifier, and the shared secret MAC session key. The customer identifier may comprise a unique alphanumeric identifier assigned to a user of the contactless card, and the identifier may distinguish the user of the contactless card from other contactless card users. In some examples, the customer identifier may identify both a customer and an account assigned to that customer and may further identify the contactless card associated with the customer's account.

In step 425, the processor encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 430, the processor transmits a cryptogram to the receiving device. The receiving device can the contactless card 110. The cryptogram can include the applet information, the unique customer identifier, the counter value, and the encrypted MAC.

In step 435, the server validates the cryptogram. The server may be a part of the transmitting device or receiving device. Alternatively, the server may be a separate entity.

In step 440, the receiving device generates its own UDKs (unique diversified keys) using the unique customer identifier and the master key. The unique customer identifier is derived from the validated cryptogram. Recall that the receiving device has already been provisioned with the master key.

In step 445, the receiving device generates two session keys: one ENC (encryption) session key and one MAC (message authentication code) session key. The receiving device may generate these session keys from the UDKs and the counter value. The counter value can be derived from the cryptogram.

In step 450, the receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

In step 455, the receiving device validates the MAC with the MAC session key generated in step 415. The receiving device may validate the MAC over the unique customer identifier and the counter value.

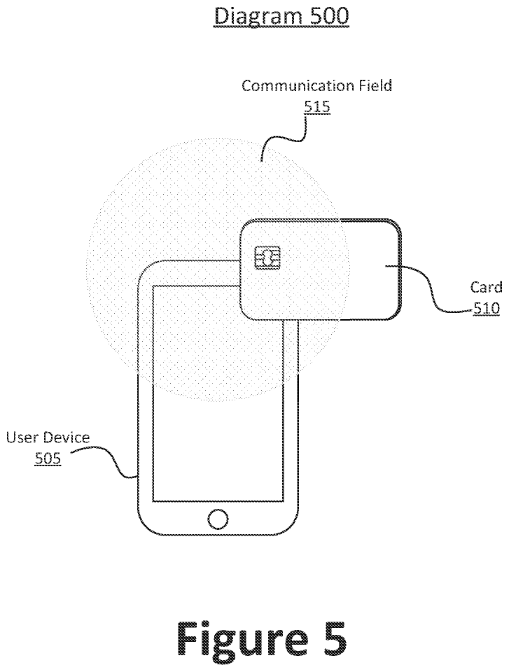

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats, and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the card are in close contact with each other so that they can exchange information within the communication field.

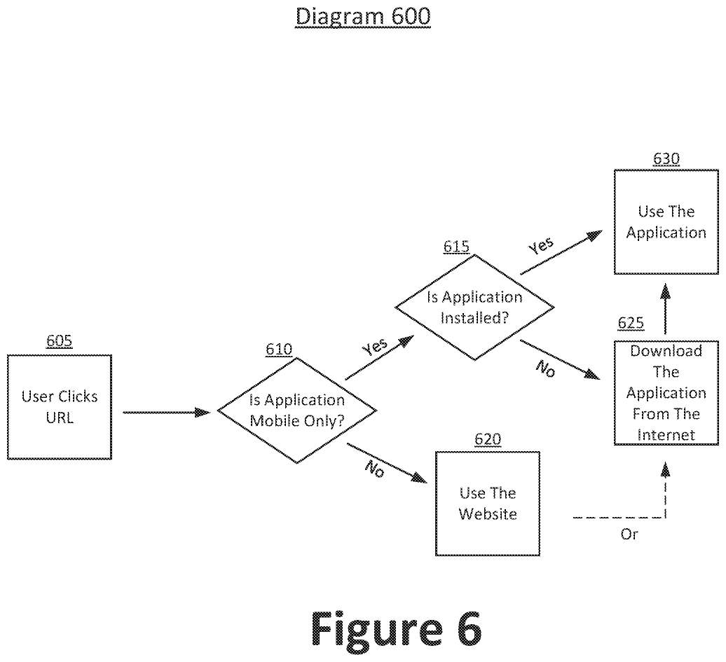

FIG. 6 is a method diagram describing an interaction with a URL according to exemplary embodiment. The diagram 600 operates under the assumption that a user has been sent a URL.

In action 605, the user clicks a URL that has been sent to them. The user may be on a computer-enabled device such as a smart phone, computer, tablet, smart watch, or some other device. In other transactions, the two device may be a smart phone and a reader, a contactless card and a reader, two separate smart phones, two contactless cards, or any two NFC-enabled devices interacting within a communication field.

The two available options for interacting with an application would be through a website or a mobile application. Mobile apps are sometimes called native apps. Websites or website applications are applications that are available used on HTML5 or CSS and require minimum device memory since they are run through a browser. The user is redirected on a specific web page, and all information is saved on a server-based database. Web apps require a stable connection to be used. Mobile apps are built for a specific mobile operating system, usually iOS or Android although other operating systems not listed may be used.

After the user has clicked the URL, two paths are provided in action 610. If the URL is linked to an application that is not mobile only, e.g. the application can run on either an application or a website, then the user may proceed to action 620 in which the user simply runs the application on a website. If the application is mobile only, then the path proceeds to action 615 where another split presents itself: is the application already installed? If yes, then the path proceeds to action 630 where the user uses the mobile application itself. If no, then the path proceeds to action 625 where the user downloads the app from an app store, a website, or some other computer-enabled network. Alternatively, a user may proceed from action 620 to action 625 if they wish to interact with the mobile application rather than the website.

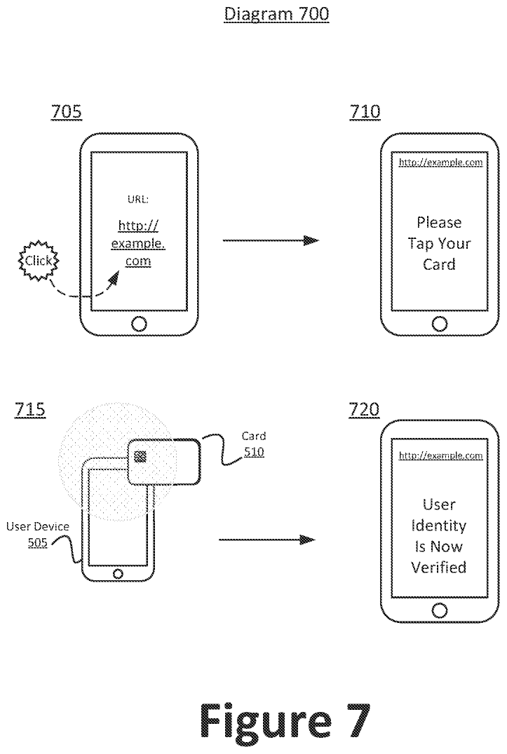

FIG. 7 is diagram illustrating a method of user verification according to an exemplary embodiment. The diagram includes a mobile device, a contactless card, and a server performing background functions. In other embodiments, this process can include other smart devices such as tablets, computers, smart watches, storage devices, smart home appliances, ATMS, or other computer-enabled devices.

In action 705, the user device receives a URL link. The diagram depicts the user device as a smart mobile device with a display screen. The URL can be sent to the user device through a short message service (SMS) message over a network. The URL can be sent by a processor associated with a server. Once presented with the URL, the user may click the URL. In an exemplary embodiment, the URL link can direct the user device to a website, a website application, or a mobile application. Additionally, the URL may contain a customer ID associated with the user's account on the website or mobile application.

In addition to the authentication challenge, the contactless card may also send a customer ID to server. The customer ID is discussed further with reference to FIG. 4. In this context, the customer ID can be used by the server to understand which customer is engaging in the authentication challenge.

In action 710, user devices prompt the user to tap the card to the phone. This prompt may be sent by the URL link associated with website or mobile application. The user may receive this prompt while on a website or on a mobile application. The prompt may be transmitted by a server over a network.

In action 715, the user device and the contactless card enter a communication field and conduct an NFC transaction of information. The URL can contain a command to establish an NFC connection between the user device and the contactless card. The exchange of information may be performed by the processor in the smart device or the card. It is understood that this NFC exchange of information can be performed by one or more application data protocol units (APDUs) associated with the contactless card. The information being exchange can be device information, card information, user identity information, financial information, or some other secure information suitable for verifying a user's identity. Action 715 may include the process of diversified key exchange further explained with reference to FIG. 4.

The URL can contain an authentication challenge that can be sent to the contactless card. Once the NFC connection is established, the URL may send this authentication challenge to the contactless card. The contactless card can complete the authentication challenge, then send the completed challenge back to the application associated with the URL. In an exemplary embodiment, the authentication challenge may be a code that is sent to the contactless card, signed by the contactless card, then transmitted back to the application associated with the URL or to a server.

If the URL is associated with a website instead of a mobile application, the website can be provisioned with a Web NFC tag that automatically reads the contactless card. Generally, Web NFC tags provide websites the ability to read and write to NFC tags in close proximity with user devices. The website associated with the URL can be provisioned with a Web NFC tag that sends an authentication challenge to the contactless card. When the contactless card returns an authentication challenge credential, the Web NFC tag can transmit the credential to the server where the credential can be validated.

In another example, the digital signature can be validated using message authentication codes (MACs) through authenticated encryption. In an exemplary embodiment, the user device and the server are provisioned with a secret MAC key or some pre-shared key. Using the MAC key and a predetermined MAC algorithm, the user device generates a MAC from the authentication challenge credential. The authentication challenge credential and the MAC are sent to the server. The server uses the pre-shared key and the same predetermined MAC algorithm to generate its own MAC. If the user device's MAC and the server's MAC are the same, then it can be determined that the authentication challenge credential is valid.

In another example, the authentication challenge can be conducted through public key and private key exchanges. The public kay can be provisioned to both the contactless card and the server. In response to the authentication challenge, the contactless card can figuratively sign the authentication challenge with the private key. This step creates the authentication credential. Then, the authentication credential can be encrypted with the public key and sent to the server over a network. The network can decrypt the authentication credential using the public key and private key used as a signature. Recall that the server has already been provisioned with the public key.

In another exemplary embodiment, the URL can contain a predetermined set of parameters associated with a GET request. GET requests are a kind of HTTP request method used to retrieve and request data from a specified resource in a server. A GET request can be used to retrieve whatever information is identified by a URL. As an example, the URL can send an encrypted GET request that is requesting website information from the server. Alternatively, the GET request can have a set of parameters, one or more of which can be encrypted. To decrypt the GET request or its parameters, the user may tap the contactless card to the user device at which point the contactless card can decrypt the GET request by a diversified key exchange. Once the GET request has been decrypted, the user device can be directed to the website associated with the URL.

In another example, the URL can transmit a unique counter value to the contactless card and the server. Counter values and diversified key exchanges are explained further with reference to FIG. 4. The contactless card and the server can be provisioned with the same master key. Using the master key, the contactless card and the server can generate a session key over the unique counter value. The counter value can change for each time period or transaction. Because both the contactless card and the server have the same master key and counter value, their session keys are identical. The session keys can be used to encrypt and decrypt the digital signature provided by the contactless card in response to the authentication challenge issued by the URL.

It is understood that one or more authentication challenges can be issued to the user. In addition to the contactless card challenge, a one-time password challenge (OTP) can be issued to the user. The server can transmit, over a network, a one-time password or code to the user device. Then, the server can transmit a request to the user device to type in the one-time password. Once the user device has received the one-time password, the user can submit the password in response to the request. The server can receive this response and validate the user.

In action 720, the website or application verifies the user's identity. The server may validate the completed authentication challenge. The verification may be performed by the processor or a predetermined algorithm. The processor may be a part of the user device or the server. The verification message may be sent by a processor over a network. Once the user has been validated, the user device or the server may perform a transaction, such as a financial transaction, secure access transaction, or any transaction requiring the secure verification of a user.

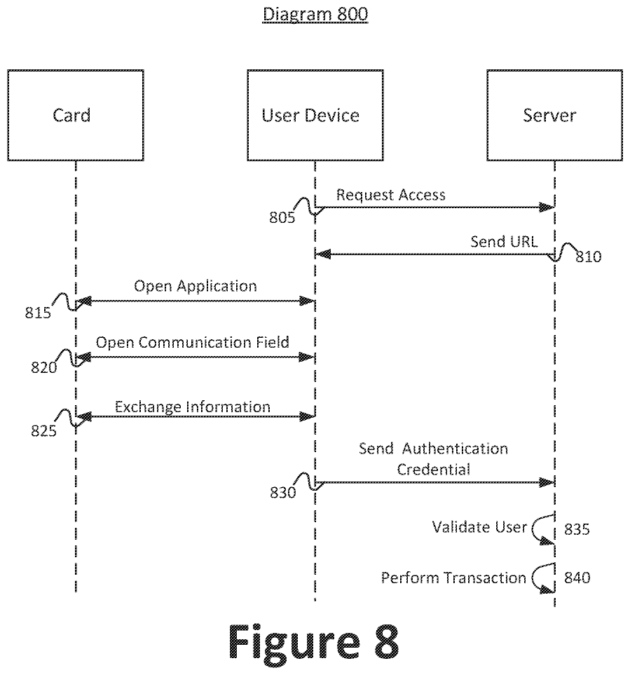

FIG. 8 is a sequence diagram illustrating a process of user identity verification according to an exemplary embodiment. In this example, the process includes a contactless card, a user device, and a server. The user device and sever can be the same referenced in FIG. 1. The card can be the same referenced in FIGS. 2 and 3. In other embodiments, this process can include other smart devices such as tablets, computers, smart watches, storage devices, smart home appliances, ATMS, or other computer-enabled devices.

The exemplary process can begin with action 805 in which the user device requests access from a server. The request can be associated with a request to perform a transaction, such as a financial transaction or some other secure access function. In response to the request for access, in action 810 the server will send a URL to the user device. The URL can be associated with a website, a mobile application, or both. The transmission can be performed by a processor associated with the server. The URL may be sent over a network. The URL may contain a customer ID associated with the user's account on the website or mobile application.

In addition to the authentication challenge, the contactless card may also send a customer ID to the server. The customer ID is discussed further with reference to FIG. 4. In this context, the customer ID can be used by the server to understand which customer is engaging in the authentication challenge.

In action 815, the user device opens the application associated with the URL. This action can be performed by a processor which may be a part of the user device or the contactless card. Next, an NFC-capable communication field is opened between the user device and the card in action 820. This action can be performed by either or both the card and the user device. Also, the URL can contain a command to establish an NFC connection between the user device and the contactless card. This connection can be initiated when the customer clicks on the URL. NFC capabilities are explained with further reference to FIG. 5. Once the communication field is open, in action 825 the card and the user device exchange information. The exchange can be performed by a processor associated with either or both the card and the user device. It is understood that this NFC exchange of information can be performed by one or more application data protocol units (APDUs) associated with the contactless card. The information being exchanged can be user information such as financial information, identity information, consumer information, or some other secure information suitable for identifying a user's identity. This information creates the user authentication credential.

The URL can contain an authentication challenge that can be sent to the contactless card. Once the NFC connection is established, the URL may send this authentication challenge to the contactless card. The contactless card can complete the authentication challenge, then send the completed challenge back to the application associated with the URL. In an exemplary embodiment, the authentication challenge may be a code that is sent to the contactless card, signed by the contactless card, then transmitted back to the application associated with the URL or to a server.

If the URL is associated with a website instead of a mobile application, the website can be provisioned with a Web NFC tag that automatically reads the contactless card. Generally, Web NFC tags provide websites the ability to read and write NFC tags in close proximity with user devices. The website associated with the URL can be provisioned with a Web NFC tag that sends an authentication challenge to the contactless card. When the contactless card returns an authentication challenge credential, the Web NFC tag can transmit the credential to the server where the credential can be validated. It is understood that the user may write the Web NFC tag to perform a different function.

In another example, the digital signature can be validated using message authentication codes (MACs) through authenticated encryption. In an exemplary embodiment, the user device and the server are provisioned with a secret MAC key or some pre-shared key. Using the MAC key and a predetermined MAC algorithm, the user device generates a MAC from the authentication challenge credential. The authentication challenge credential and the MAC are sent to the server. The server uses the pre-shared key and the same predetermined MAC algorithm to generate its own MAC. If the user device's MAC and the server's MAC are the same, then it can be determined that the authentication challenge credential is valid.

In another example, the authentication challenge can be conducted through public key and private key exchanges. The public kay can be provisioned to both the contactless card and the server. In response to the authentication challenge, the contactless card can figuratively sign the authentication challenge with the private key. This step creates the authentication credential. Then, the authentication credential can be encrypted with the public key and sent to the server over a network. The network can decrypt the authentication credential using the public key and private key used as a signature. Recall that the server has already been provisioned with the public key. Thus, the server validates the user.

In another exemplary embodiment, the URL can contain a predetermined set of parameters associated with a GET request. GET requests are a kind of HTTP request method used to retrieve and request data from a specified resource in a server. A GET request can be used to retrieve whatever information is identified by a URL. As an example, the URL can send an encrypted GET request that is requesting website information from the server. Alternatively, the GET request can have a set of parameters, one or more of which can be encrypted. To decrypt the GET request or its parameters, the user may tap the contactless card to the user device at which point the contactless card can decrypt the GET request by a diversified key exchange. Once the GET request has been decrypted, the user device can be directed to the website associated with the URL.

In another example, the URL can transmit a unique counter value to the contactless card and the server. Counter values and diversified key exchanges are explained further with reference to FIG. 4. The contactless card and the server can be provisioned with the same master key. Using the master key, the contactless card and the server can generate a session key over the unique counter value. The counter value can change for each time period or transaction. Because both the contactless card and the server have the same master key and counter value, their session keys are identical. The session keys can be used to encrypt and decrypt the digital signature provided by the contactless card in response to the authentication challenge issued by the URL.

It is understood that one or more authentication challenges can be issued to the user. In addition to the contactless card challenge, a one-time password challenge (OTP) can be issued to the user. The server can transmit, over a network, a one-time password or code to the user device. Then, the server can transmit a request to the user device to type in the one-time password. Once the user device has received the one time password, the user can submit the password in response to the request. The server can receive this response and validate the user.

In action 830, the user device sends the authentication credential to the server. This action can be performed by a processor associated with the processor. Once the server receives the credential, the server can validate the user in action 835 through a processor or some predetermined algorithm. After the server validates the user, the server will perform the transaction in action 840.

The transaction can be one selected from the following non-limiting list of examples: depositing or withdrawing funds; accessing a secure area such as a living space or a storage space; accessing a vehicle; accessing a reservation at a place of business; verifying the user's identity for a consumer website used for purchasing goods or services; or some other financial transaction.

In some aspects, the techniques described herein relate to a system for validating a user's identity, the system including: a card; a user device; a server, the server further including: a memory, and a processor configured to: transmit an authentication request to the user device, the authentication request further including a uniform resource locator (URL); open, in response to the authentication request, a communication field between the user device and the card; receive an authentication credential from the card; validate the authentication request; and perform a transaction.

In some aspects, the techniques described herein relate to a system, wherein the user device is at least one selected from the group of a smart phone, tablet, or computer.

In some aspects, the techniques described herein relate to a system, wherein the authentication request is sent in a short message service (SMS).

In some aspects, the techniques described herein relate to a system, wherein the processor is further configured to direct the user device to a website associated with the URL.

In some aspects, the techniques described herein relate to a system, wherein the processor is further configured to direct the user device to a mobile application associated with the URL.

In some aspects, the techniques described herein relate to a system, wherein the communication field is at least one selected from the group of near field communication (NFC), Bluetooth, or radio frequency identification (RFID).

In some aspects, the techniques described herein relate to a system, wherein the transaction is financial transaction through at ATM or banking institution.

In some aspects, the techniques described herein relate to a method for validating a user's identity, the method including the steps of: transmitting, by a processor, an authentication request to a user device, the authentication request further including a uniform resource locator (URL); directing, by a processor, the user device to an application; opening a communication field between a user device and a card; receiving, by a processor, an authentication credential from the card; validating the authentication request; and performing a transaction.

In some aspects, the techniques described herein relate to a method, wherein the user device is at least one selected from the group of a smart phone, tablet, or computer.

In some aspects, the techniques described herein relate to a method, wherein the authentication request is sent in a multimedia message service (MMS).

In some aspects, the techniques described herein relate to a method, wherein the user device is a smart watch.

In some aspects, the techniques described herein relate to a method, where the transaction is a secure access transaction for entering a living space or abode.

In some aspects, the techniques described herein relate to a method, wherein the transaction is a secure access transaction for opening one or more secure storage spaces.

In some aspects, the techniques described herein relate to a method, wherein the authentication credential is a digital signature from the card.

In some aspects, the techniques described herein relate to a method, wherein the authentication request and authentication credential are transmitted and received through an application protocol data unit (APDU).

In some aspects, the techniques described herein relate to a method, wherein the method further includes, before the final step of performing a transaction, the additional steps of: transmitting, over the processor, a one-time password (OTP) to the user device; receiving, over the processor, a passcode from the user device; validating the user; and performing a transaction.

In some aspects, the techniques described herein relate to a computer-accessible non-transitory medium including computer executable instructions that, when executed on a processor, perform procedures including the steps of: transmitting, by a processor, an authentication request to a user device, the authentication request further including a uniform resource locator (URL); directing, by a processor, the user device to an application; opening a communication field between a user device and a card; receiving, by a processor, an authentication credential from the card; validating the user device; and performing a transaction.

In some aspects, the techniques described herein relate to a computer-accessible non-transitory medium, wherein the user device is at least one selected from the group of a smart phone, tablet, or computer.

In some aspects, the techniques described herein relate to a computer-accessible non-transitory medium, wherein the user device is an automated teller machine (ATM).

In some aspects, the techniques described herein relate to a computer-accessible non-transitory medium, wherein the steps further include transmitting the authentication request by a short message service (SMS) or a multimedia message service (MMS).

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Although some embodiments of the invention are illustrated and described herein, the present disclosure it is not intended to be limited to the details shown because various modifications and structural changes may be made therein without departing from the spirit of the invention and within the scope and range of equivalents of the attributes described. Additionally, well-known elements of exemplary embodiments of the invention are not described in detail or omitted so as not to obscure the relevant details of the invention.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

We claim:

1. A system for validating a user's identity, the system comprising:
a card;
a user device; and
a server, the server further comprising:
a memory, and
a processor configured to:
transmit an authentication request to the user device, the authentication request further comprising a uniform resource locator (URL);
open, in response to the authentication request, a communication field between the user device and the card;
receive an authentication credential from the card;
validate the authentication request; and
perform a transaction.

2. The system of claim 1, wherein the user device is at least one selected from the group of a smart phone, tablet, or computer.

3. The system of claim 1, wherein the authentication request is sent in a short message service (SMS).

4. The system of claim 1, wherein the processor is further configured to direct the user device to a website associated with the URL.

5. The system of claim 1, wherein the processor is further configured to direct the user device to a mobile application associated with the URL.

6. The system of claim 1, wherein the communication field is at least one selected from the group of near field communication (NFC), Bluetooth, or radio frequency identification (RFID).

7. The system of claim 1, wherein the transaction is financial transaction through at ATM or banking institution.

8. A method for validating a user's identity, the method comprising the steps of:
transmitting, by a processor, an authentication request to a user device, the authentication request further comprising a uniform resource locator (URL);
directing, by a processor, the user device to an application;
opening a communication field between a user device and a card;
receiving, by a processor, an authentication credential from the card;
validating the authentication request; and
performing a transaction.

9. The method of claim 8, wherein the user device is at least one selected from the group of a smart phone, tablet, or computer.

10. The method of claim 8, wherein the authentication request is sent in a multimedia message service (MMS).

11. The method of claim 8, wherein the user device is a smart watch.

12. The method of claim 8, where the transaction is a secure access transaction for entering a living space or abode.

13. The method of claim 8, wherein the transaction is a secure access transaction for opening one or more secure storage spaces.

14. The method of claim 8, wherein the authentication credential is a digital signature from the card.

15. The method of claim 8, wherein the authentication request and authentication credential are transmitted and received through an application protocol data unit (APDU).

16. The method of claim 8, wherein the method further comprises, before the final step of performing a transaction, the additional steps of:
transmitting, over the processor, a one-time password (OTP) to the user device;
receiving, over the processor, a passcode from the user device;
validating the user; and
performing a transaction.

17. A computer-accessible non-transitory medium comprising computer executable instructions that, when executed on a processor, perform procedures comprising the steps of:
transmitting, by a processor, an authentication request to a user device, the authentication request further comprising a uniform resource locator (URL);
directing, by a processor, the user device to an application;
opening a communication field between a user device and a card;
receiving, by a processor, an authentication credential from the card;
validating the user device; and
performing a transaction.

18. The computer-accessible non-transitory medium of claim 17, wherein the user device is at least one selected from the group of a smart phone, tablet, or computer.

19. The computer-accessible non-transitory medium of claim 17, wherein the user device is an automated teller machine (ATM).

20. The computer-accessible non-transitory medium of claim 17, wherein the steps further comprise transmitting the authentication request by a short message service (SMS) or a multimedia message service (MMS).
